(19) United States
(12) Patent Application Publication
(10) Pub. No.: US 2005/0287438 A1
(43) Pub. Date: Dec. 29, 2005

(54) Alkaline electrochemical cell with improved lifetime

(75) Inventors: Patrick Bernard, Bordeaux (FR); Lionel Goubault, Merignac (FR); Thierry Hezeque, Aubie-Espessas (FR)

Correspondence Address: SUGHRUE MION, PLLC, 2100 PENNSYLVANIA AVENUE, N.W., SUITE 800, WASHINGTON, DC, 20037, US

(73) Assignee: SAFT

(21) Appl. No.: 11/159,226

(22) Filed: Jun. 23, 2005

(30) Foreign Application Priority Data
Jun. 25, 2004 (FR) 0406993

(51) Int. Cl. H01M 4/32

(52) U.S. Cl. 429/223

(57) ABSTRACT

The invention relates to an alkaline electrochemical cell of improved lifetime, including at least one compound based on barium or strontium, said compound being present in the cell with the exception of the cathode. The invention also provides a method of fabricating such a cell.

### TECHNICAL FIELD

The invention relates to an alkaline electrochemical cell with improved lifetime, and also to methods of preparing it.

### STATE OF THE ART

Alkaline electrochemical cells, also known as alkaline storage cells, are generally of the NiCd or the NiMH type. The main factor limiting the lifetime of NiMH storage cells is corrosion of the hydridable alloy of the negative electrode. Without seeking to be tied to any particular theory, the Applicant believes that the corrosion reaction of the alloy in an alkaline medium leads to water being consumed, and thus to the separator drying out, thereby increasing the internal resistance of the cell and consequently reducing its electrochemical power. In order to reduce the rate of alloy corrosion, a large amount of work has been done on reducing corrosion kinetics. Nevertheless, the scope for modifying the composition of the alloy remains very limited because of the constraints put on the alloy (high capacity, unchanged hydrogen plateau pressure, etc.). In addition, solutions relying on adding compounds for reducing corrosion kinetics (in particular yttrium oxide) are expensive and difficult to implement. These problems arise for all types of alkaline storage cell.

Alkaline electrochemical cells with improved lifetime are therefore being researched.

EP-A-1 006 598 describes depositing, on a sintered type positive electrode, a first layer of Co(OH)₂ followed by a second layer of a material that may be Ba(OH)₂ or Sr(OH)₂. Those layers are stated as increasing capacity during high-current discharge and improving the self-discharge of the storage cell.

EP-A-0 587 974 describes adding Ba(OH)₂ or Sr(OH)₂ in the positive electrode, and also Co and Mn or Ti and V in the negative electrode, in particular for the purpose of improving the chargeability of the storage cell, when hot.

U.S. Pat. No. 2,001,033970 describes adding cobalt in the sintered type positive electrode and depositing a layer, e.g. of Sr(OH)₂.

U.S. Pat. No. 2,003,129491 describes adding Sr(OH)₂ in the sintered type positive electrode, and also adding a hydroxide of a metal selected from Sc, Y, and Ln in the negative electrode. Such addition is stated as preventing Ni oxidizing in the negative electrode alloy by the oxygen produced at the positive electrode during charging. That document also describes improved cycling characteristics, in particular at low temperature. That document also relies on adding compounds of the type based on yttrium.

None of the above documents teaches or describes the cell of the invention.

### SUMMARY OF THE INVENTION

The invention thus provides an alkaline electrochemical cell with improved lifetime including at least one compound based on barium or on strontium, said compound being present in the cell with the exception of the cathode. The invention also describes the method of fabricating such a cell.

### DETAILED DESCRIPTION OF EMBODIMENTS OF THE INVENTION

The cell or storage cell (these two terms being used interchangeably in the present description) comprises in general manner a positive electrode and a negative electrode, a separator between them, and an electrolyte. The cell may be of the button type, the cylindrical type (with a spool or a spiral winding), or of the prismatic type.

The positive electrode comprises an electrochemically active material that is mainly a nickel hydroxide Ni(OH)₂, possibly together with one or more hydroxides of other compounds such as Zn, Co, Ca, Cd, Mg, Mn, Al, etc. which are syncrystallized with the nickel hydroxide.

The negative electrode comprises an electrochemically active material which may be cadmium or a hydridable intermetallic compound M (in particular of the type AB₅ such as polysubstituted LaNi₅), or any material that is conventional in the art. These are referred to respectively as alkaline storage cells of the NiCd type and of the NiMH type. It is also possible to make use of the following couples: Ni/Fe; Ni/H₂; or Ni/Zn.

The electrolyte is a concentrated alkaline aqueous solution comprising at least one hydroxide (KOH, NaOH, LiOH), at a concentration that is generally of the order of several times normal.

The separator is generally made of non-woven porous polyamide or polyolefin (e.g. polypropylene) fibers.

The cell of the invention includes, either in the negative electrode or in the cell housing or “element” itself, a compound based on barium or on strontium which can be selected from the group consisting of: barium oxide BaO, strontium oxide SrO, barium hydroxide Ba(OH)₂, strontium hydroxide Sr(OH)₂, barium sulfate BaSO₄, strontium sulfate SrSO₄, and mixtures thereof. Barium hydroxide Ba(OH)₂ and strontium hydroxide Sr(OH)₂ are preferred.

For a sealed cell, the quantity added is generally less than or equal to 6×10⁻³ moles per ampere hour (mol/Ah) of barium or strontium, and preferably lies in the range 1×10⁻³ mol/Ah to 6×10⁻³ mol/Ah, and advantageously lies in the range 3×10⁻³ mol/Ah to 6×10⁻³ mol/Ah.

For a non-sealed cell, the quantity added may be greater than 6×10⁻³ mol/Ah.

The method of preparing a cell of the invention is similar to methods of fabricating conventional cells (without the added compound).

In conventional manner, pastes are prepared for the electrodes, the electrodes are fabricated, then the positive electrode, a separator, and the negative electrode are superposed. The stack is impregnated with an aqueous alkaline electrolyte. Thereafter the cell is closed.

The invention applies to any electrode configuration.

In a first implementation, in which the cell has the compound in the negative electrode, the method of manufacture comprises the following steps:
i) preparing a negative electrode paste including said compound;
ii) assembling the negative electrode; and
iii) assembling said cell with said negative electrode.

It is also possible to deposit a layer of said compound on the surface of the negative electrode.

In a second embodiment, for which the cell contains the compound directly in the element, the compound may be introduced, for example, in the core of an element (in particular a cylindrical element) above or below the stack, in the separator, or in suspension in the electrolyte. These examples are not limiting in any way.

In a second implementation, the method of fabricating a cell of the invention comprising an electrochemical stack in a can, comprises the following steps:
i) preparing an electrochemical stack;
ii) introducing said compound into the can;
iii) inserting the stack into said can, or optionally inverting steps ii) and iii); and
iv) performing final assembly of the cell.

It should be understood that it is possible to combine the barium compound and/or the strontium compound both in accordance with the invention and in the cathode (i.e. in accordance with the prior art).

As has been observed, the solution of the invention is very simple and/or does not present any significant extra cost.

The secondary cell of the invention can be applied in all of the conventional fields, such as roaming or fixed appliances.

The storage cell of the invention may be of the open type (open or semi-open) or of the sealed type.

### EXAMPLES

The following examples illustrate the invention without limiting it.

A reference positive electrode P1 was made with a paste having the following composition in percentage by weight:

| | |
|---|---|
| Active material | 71 |
| conductive material Co(OH)₂ | 8 |
| PTFE binder | 0.8 |
| CMC cellulose polymer | 0.2 |
| water | 20 |

The electrochemically active material in powder form was constituted by a nickel-based hydroxide and contained the following additives: cobalt and zinc. The viscosity of the paste was adjusted with water. The paste was introduced into a three-dimensional conductive support in the form of a nickel foam having porosity of about 95%. Once the paste has been introduced into the support, the assembly was dried in order to eliminate the water therefrom, rolled, and then cut to obtain an electrode having the desired dimensions. The finished electrode presented porosity of 30% and grammage of 17.5 grams per square decimeter (g/dm²).

A positive electrode P2 was made with a paste having the following composition in percentage by weight:

| | |
|---|---|
| active material | 66.3 |
| conductive material Co(OH)₂ | 8 |
| Ba(OH)₂ | 4.7 |
| PTFE binder | 0.8 |
| CMC cellulose polymer | 0.2 |
| water | 20 |

The same method was used as for the electrode P1. The dimensional characteristics of the positive electrode were identical to those of the positive electrode P1. Adding 4.7% of Ba(OH)₂ corresponds to adding 1.17×10⁻³ mol/Ah in the element.

A positive electrode P3 was made with a paste having the following composition in percentage by weight:

| | |
|---|---|
| active material | 66.3 |
| conductive material Co(OH)₂ | 8 |
| Sr(OH)₂ | 4.7 |
| PTFE binder | 0.8 |
| CMC cellulose polymer | 0.2 |
| water | 20 |

The same method was followed as for the electrode P2. Adding 4.7% of Sr(OH)₂ in the positive electrode corresponding to adding 1.64×10⁻³ mol/Ah in the element.

A negative reference electrode N1 was made using a paste having the following composition in percentage by weight:

| | |
|---|---|
| active material | 80 |
| SBR binder | 0.5 |
| carbon | 0.3 |
| CMC cellulose polymer | 0.2 |
| water | 19 |

The electrochemically active material was an intermetallic compound of the AB₅ type capable of forming a hydride once charged. The viscosity of the paste was adjusted with water. The paste was introduced into a conductive support constituted by nickel foam. The assembly was then dried in order to eliminate water therefrom and then rolled to a porosity of 25% in order to obtain the electrode. The capacity of the negative electrode was greater than that of the positive electrode.

A negative electrode N2 was made with a paste having the following composition in percentage by weight:

| | |
|---|---|
| active material | 76.2 |
| Ba(OH)₂ | 3.8 |
| SBR binder | 0.5 |
| carbon | 0.3 |
| CMC cellulose polymer | 0.2 |
| water | 19 |

The same method was followed as for the electrode N1. Adding 3.8% of Ba(OH)₂ in the negative electrode corresponds to adding 1.1 7×10⁻³ mol/Ah in the element.

A negative electrode N3 was made with a paste having the following composition in percentage by weight:

| | |
|---|---|
| active material | 76.2 |
| Sr(OH)₂ | 3.8 |
| SBR binder | 0.5 |
| carbon | 0.3 |
| CMC cellulose polymer | 0.2 |
| water | 19 |

The same method was used as for the electrode Ni. Adding 3.8% of Sr(OH)₂ in the negative electrode corresponds to adding 1.64×10⁻³ mol/Ah in the element.

Sealed secondary electrochemical NiMH cell of AA format with a nominal capacity C of 1200 milliampere hours (mAh) was made up of from the above-described positive and negative electrodes. The electrodes were separated by a non-woven separator of polypropylene in order to form the electrochemical stack. The stack was spiral wound and inserted into a metal can in which it was impregnated with an alkaline electrolyte, specifically an aqueous alkaline solution constituted by a mixture of 7.5N potassium hydroxide (KOH), 0.4N sodium hydroxide (NaOH), and 0.5N lithium hydroxide (LiOH) in order to constitute the storage cell. Eleven storage cells of that type were made. The characteristics of the active materials of those eleven cells are given in Table 1. Storage cell A was the reference. For storage cells D to I, the barium or strontium hydroxide powder was introduced into the core of the element in the empty space prior to filling it with electrolyte.

TABLE 1

| Ex | Positive | Negative | Ba(OH)₂ (mol/Ah) | Sr(OH)₂ (mol/Ah) |
|---|---|---|---|---|
| A | P1 | N1 | 0 | 0 |
| B | P2 | N1 | 1.17 × 10⁻³ | 0 |
| C | P3 | N1 | 0 | 1.64 × 10⁻³ |
| D | P1 | N1 | 1.17 × 10⁻³ | 0 |
| E | P1 | N1 | 2.91 × 10⁻³ | 0 |
| F | P1 | N1 | 5.84 × 10⁻³ | 0 |
| G | P1 | N1 | 8.75 × 10⁻³ | 0 |
| H | P1 | N1 | 0 | 1.64 × 10⁻³ |
| I | P1 | N1 | 0 | 4.1 × 10⁻³ |
| J | P1 | N2 | 1.17 × 10⁻³ | 0 |
| K | P1 | N3 | 0 | 1.64 × 10⁻³ |

Electrochemical Performance

After resting for 48 hours (h) at ambient temperature and after nine activation cycles, the internal pressure in the element was measured while charging at C/I for 2 h. The safety valve was calibrated to trigger at a pressure greater than 16 bars.

The storage cells were then subjected to a cycling test at ambient temperature, defined as follows:
charging for 66 minutes at a constant current of C/I;
resting for 3 minutes; and
discharging at a constant current of C/I down to a voltage of 0.9V across the terminals of the element.

The capacity on cycle 11 and the number of cycles required for the capacity of the element to drop below 80% of its nominal capacity are given in Table 2.

TABLE 2

| | Ex | | | | | | | | | | |
|---|---|---|---|---|---|---|---|---|---|---|---|
| | A | B | C | D | E | F | G | H | I | J | K |
| Capacity | 1211 | 1180 | 1175 | 1210 | 1205 | 1218 | 1100 | 1210 | 1210 | 1208 | 1215 |
| on cycle | | | | | | | | | | | |
| 11 (mAh) | | | | | | | | | | | |
| Maximum | 8.5 | 8.6 | 8.6 | 9.3 | 10.5 | 13.1 | 16.5 | 9.2 | 11.1 | 8.6 | 8.3 |
| pressure | | | | | | | | | | | |
| (bar) | | | | | | | | | | | |
| Lifetime | 347 | 343 | 338 | 377 | 407 | 455 | 212 | 395 | 421 | 369 | 381 |
| (cycles) | | | | | | | | | | | |

These results show that adding barium or strontium in the storage cell does not change the electrochemical performance of the storage cells when discharging at C/1.

The results of examples B and C show that there is no improvement in cycling lifetime when the barium or strontium hydroxide is added in the positive electrode. In contrast, when the barium or strontium hydroxide is added in the storage cell (series D through I) a considerable improvement in cycling lifetime can be seen. This improvement appears also to be correlated with the quantity of additives added. In series G, the quantity of barium hydroxide added was such that it lead to an increase in the internal pressure of the element and to its valve opening. In sealed storage cells of the invention it is preferable for the added quantity to be less than or equal to about 6×10⁻³ mol/Ah in order to ensure that the internal pressure remains below the pressure at which the valve opens (in this case 16 bars); nevertheless, this quantity could be increased by decreasing the quantity of another component of the generator.

With an open storage cell in accordance with the invention, the quantity that is added may be greater than 6×10⁻³ mol/Ah.

Examples J and K show that adding barium or strontium in the negative electrode also enables the lifetime of the storage cell to be improved.

1. An alkaline electrochemical cell including at least one compound based on barium or strontium, said compound being present in the cell with the exception of the cathode.

2. A cell according to claim 1, in which said compound is selected from the group consisting of: barium oxide BaO, strontium oxide SrO, barium hydroxide Ba(OH)₂ strontium hydroxide SR(OH)₂, barium sulfate BaSO₄, strontium sulfate SrSO₄, and mixtures thereof.

3. A cell according to claim 2, in which the compound is barium hydroxide Ba(OH)₂.

4. A cell according to claim 2, in which the compound is strontium hydroxide Sr (OH)₂.

5. A cell according to claim 1,
added in a quantity less than or equal to 6×10⁻³ mol/Ah of barium or strontium, preferably in the range 1×10⁻³ mol/Ah to 6×10⁻³ mol/Ah advantageously in the range 3×10⁻³ mol/Ah to 6×10⁻³ mol/Ah for a sealed type cell; or
added in a quantity that may exceed 6×10⁻³ mol/Ah for an open type cell.

6. A cell according to claim 1, of the NiCd type.

7. A cell according to claim 1, of the NiMH type.

8. A cell according to claim 1, in which said compound is added in the negative electrode.

9. A cell according to claim 1, in which said compound is added above or below the stack.

10. A cell according to claim 1, in which said compound is added in the separator.

11. A cell according to claim 1, in which said compound is added in suspension in the electrolyte.

12. A method of fabricating a cell according to claim 8, comprising the following steps:
i) preparing a negative electrode paste including said compound;
ii) assembling the negative electrode; and
iii) assembling said cell with said negative electrode.

13. A method of fabricating a cell according to claim 9, comprising an electrochemical stack in a can, the method comprising the following steps:
i) preparing an electrochemical stack;
ii) introducing said compound into the can;
iii) inserting the stack into said can; or steps ii) and iii) may be interchanged; and
iv) final assembly of the cell.
